(19) United States
(12) Patent Application Publication
(10) Pub. No.: US 2015/0367604 A1
(43) Pub. Date: Dec. 24, 2015

(54) COVER ASSEMBLY FOR TEMPERATURE-SENSITIVE CARTONS OR ARTICLES

(71) Applicant: Grand Designs, Inc., Sacramento, CA (US)

(72) Inventors: Adam Edward Anderson, Sacramento, CA (US); Stuart F. Spencer, Folsom, CA (US)

(21) Appl. No.: 14/742,018

(22) Filed: Jun. 17, 2015

Related U.S. Application Data
(60) Provisional application No. 62/014,294, filed on Jun. 19, 2014.

(51) Int. Cl. B32B 15/08; B32B 15/14; B32B 7/06; B32B 5/02

(52) U.S. Cl. CPC B32B 15/08; B32B 5/024; B32B 15/14; B32B 7/06; B32B 2307/304; B32B 2439/62

(57) ABSTRACT

Temperature protection assemblies (18) designed to protect objects (10) against undue temperature changes during shipping or storage, comprise a first layer (20) configured to be placed proximal to the object (10) and include phase change material, together with a second layer (22) configured to be placed over the first layer (20) and remote from the object (10), the second layer comprising a heat-reflecting material (50). The assemblies (18) may be designed to protect a single carton (10) or a pallet load thereof and, in such cases, the layers (20, 22) are in the form of open-bottom covers, which can be fitted over the carton (10) or pallet load in closely-conforming relationship, with the first layer (20) adjacent the carton (10) or load, and the second layer (22) telescoped over the first layer (20). The covers (20, 22) may be interconnected to form a unitary assembly.

### CROSS-REFERENCE TO RELATED APPLICATION

This application claims the benefit of U.S. provisional application Ser. No. 62/014,294, filed Jun. 19, 2014, which is incorporated by reference herein in its entirety.

### BACKGROUND OF THE INVENTION

1. Field of the Invention

The present invention is broadly concerned with cover assemblies designed to cover one or more objects subject to temperature degradation. More particularly, the invention is concerned with such assemblies, and methods of use thereof, where the assemblies include a first layer having phase change material (PCM) as a part thereof, together with a second layer positioned over the first layer and including heat-reflective material. The assemblies are especially designed to protect high-quality goods such as wines or chocolates during shipping and storage thereof.

2. Description of the Prior Art

Bulk goods of high quality are often shipped in railcars or trucks using quadrate paperboard cartons, the latter being stacked on pallets for ease of handling and transport. Where the goods are subject to temperature degradation, such as wines and chocolates, the temperature conditions within the railcars or trucks may be such as to harm or even destroy the goods. It has been known to cover such pallet loads with thermal insulating blanket materials in an effort to protect the goods from extreme cold or heat. However, such expedients often do not provide an adequate degree of thermal protection. There is accordingly a need in the art for improved thermal protection assemblies which can safely maintain the temperatures of shipped goods at acceptable levels.

PCM's are known products having high heats of fusion which, melting and solidifying at certain temperatures, are capable of storing and releasing large amounts of energy. Heat is absorbed or released when the material changes from solid to liquid and vice versa. Thus, PCM's are classified as latent heat storage units. Initially, solid-liquid PCM's behave like sensible heat storage materials; their temperatures rise as they absorb heat. Unlike conventional materials, however, when PCM's reach the temperature at which they change phase, they absorb large amounts of heat at almost constant temperatures. This continues until all of the material is transformed in phase. A large number of PCM's are available, either as organic, inorganic, eutectic, or hygroscopic materials.

### SUMMARY OF THE INVENTION

The present invention overcomes the problems outlined above and provides cover assemblies designed to protect objects against undue temperature changes. Generally speaking, the assemblies of the invention comprise a first layer configured to be placed proximal to the object and including PCM, and a second layer configured to be placed over the first layer and remote from the object, the second layer comprising a heat-reflecting material. In preferred forms, the first layer includes an inner sheet and an outer sheet, with the PCM captively retained between said sheets. For example, the inner and outer sheets may be formed of an appropriate flexible synthetic resin material joined at the margins thereof to form an internal pocket, with the PCM within the pocket. If desired, the inner and outer sheets may be quilted or segmented to form sub-pockets, each filled with PCM. Normally, solid-liquid PCM's are used in the invention, although this is not essential.

The second layer in general need only include a heat-reflective material such as a sheet of aluminum or metalized synthetic resin. More preferably however, the second layer has both a heat-reflective material and an insulating material. For example, the second layer may have an inner sheet of heat-insulating material, such as woven polypropylene, with an outer layer of metallic foil secured at least to the face of the second layer remote from the first layer. Still more preferably, the heat-insulating synthetic resin material has metallic foil secured to the opposed faces thereof.

In certain cases, the object to be protected is in the form of a quadrate carton presenting upright sidewalls and a top panel. In such a situation, the first layer advantageously has a top panel and four depending sidewall panels, where the panels are configured to be placed over the carton in closely-conforming relationship with the top panel and sidewalls of the carton. Furthermore, the second layer has a top panel and four depending sidewall panels, these top and sidewall panels of the second layer are configured to be placed over the first layer in closely-conforming relationship therewith.

It will also be appreciated that pallet loads made up of a plurality of stacked cartons may be protected using inner and outer layers respectively configured to cover the entire pallet load. Where the cartons of the pallet load are of identical shape and cooperatively present a top panel and vertical sidewalls, it is only necessary to fabricate the first and second layers as open-bottom covers of dimensions to fit over the entire pallet load.

In other instances, a plurality of differently sized cartons or objects may be protected by application of the first and second layers as individual sheets spanning and covering the cartons or objects. In this scenario, the first and second layers would not be pre-formed for covering of a single carton, but would rather simply be large sheets laid over the cartons of objects with the PCM layer applied first, followed by the heat reflecting layer.

### BRIEF DESCRIPTION OF THE DRAWINGS

FIG. 1 is an exploded perspective view of a shipping carton containing heat-sensitive goods, with the two components of a representative cover assembly in accordance with the invention located above the carton, namely an inner PCM cover and an outer heat-reflecting/insulating cover;

FIG. 2 is a perspective view similar to that of FIG. 1, showing the inner PCM cover positioned over the carton, with an outer heat-reflecting/insulating cover over the PCM;

FIG. 3 is a perspective view of the completed carton having the cover assembly placed thereover;

FIG. 4 is an exploded perspective view similar to that of FIG. 1, but illustrating the undersides of the carton, PCM cover, and heat-reflecting/insulating cover;

FIG. 5 is a fragmentary sectional view illustrating the construction of the outer heat-reflecting/insulating cover;

FIG. 6 is a fragmentary sectional view illustrating the construction of the inner PCM cover; and

FIG. 7 is a graph setting forth a series of temperature tests using PCM and heating-reflecting/insulating material, individually and in combination.

### DETAILED DESCRIPTION OF THE PREFERRED EMBODIMENT

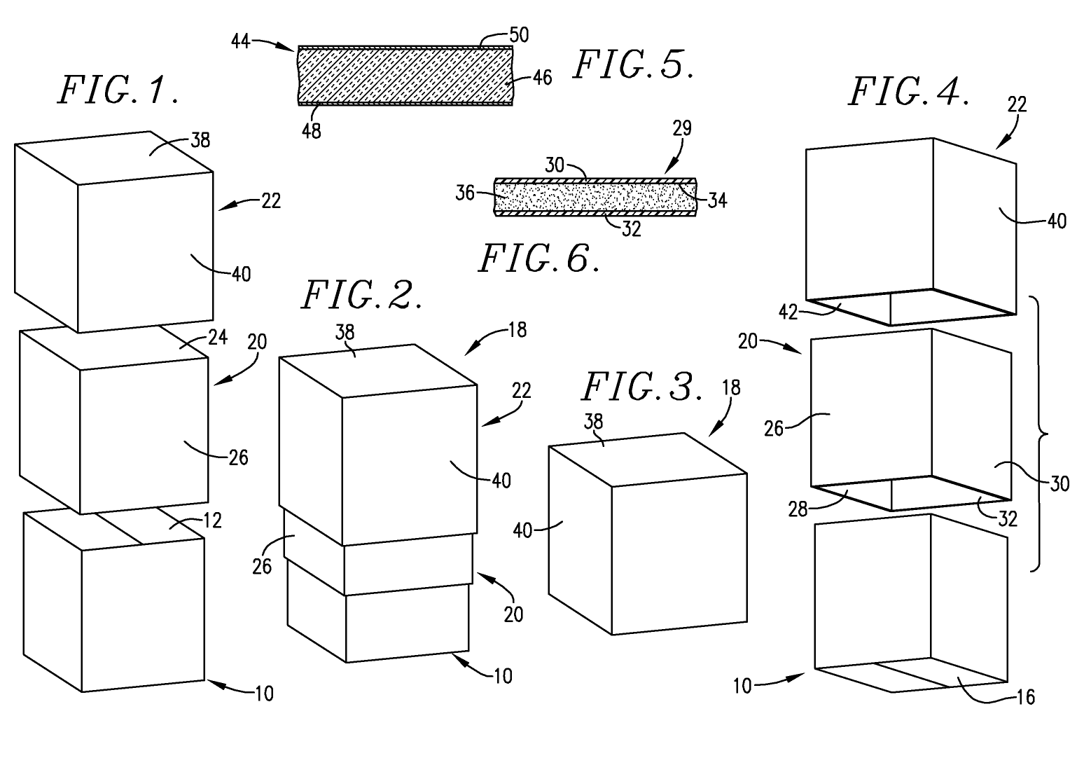

Turning now to FIGS. 1 and 3, a conventional paperboard carton 10 is illustrated, which contains heat-sensitive goods, such as high quality wine or chocolate. As illustrated, the carton 10 is generally quadrate in plan configuration, and has a top wall 12, four upstanding sidewall panels 14, and a bottom wall 16. The carton 10 as illustrated is substantially square, but it will be appreciated that cartons of essentially any shape can be used in the context of the invention.

The contents of carton 10 are thermally protected by means of an assembly 18 in accordance with the invention which generally comprises an innermost PCM cover 20 and an outermost heat-reflecting cover 22. In the depicted embodiment, the outer cover 22 is telescoped over the inner cover 20.

As illustrated, the PCM cover 20 has a top panel 24, four vertically extending side panels 26, and an open bottom 28. Additionally, the cover 20 is dimensioned to fit over the carton 10 in a closely conforming, proximal relationship, i.e., the side panels 26 are closely adjacent the carton sidewalls 14, whereas the top panel 24 overlies the carton top wall 12. Preferably, the cover 20 is designed so that the top panel 24 and side panels 26 are in physical contact with the carton top wall 12 and sidewall panels 14, although this is not essential.

The panel components of the PCM cover 20 are advantageously formed from an integrated composite 29 in the form of a pair of inner and outer sheets or webs of an appropriate synthetic resin material, which are welded together at the margins thereof to define an internal pocket; the pocket is filled with an appropriate PCM suitable for the intended use. For example, and considering one of the side panels 26, an outer sheet 30 is peripherally welded with an inner sheet 32, with the resultant pocket 34 filled with PCM 36 (FIG. 6). In the depicted embodiment, the panels 24 and 26 of the cover 20 are interconnected, but this is not essential. Moreover, the panels 24, 26 may be of segmented or quilted design to form sub-pockets, in order to prevent undue settling of the PCM 36.

The PCM 36 within the composite 29 can be selected from a variety of candidates, and the choice is primarily dictated by the design of cover 20 and the degree of temperature maintenance required for the product to be protected. For example, the PCM may be a mixture of organic oil(s) and fatty acid(s), or paraffin(s), saline solution(s), and/or glycol gel(s).

The outer heat-reflecting/insulating cover 22 is designed to be fitted over the cover 20 and includes a top panel 38, four vertically extending side panels 40, and an open bottom 42. Advantageously, the cover 22 is dimensioned to fit over the cover 20 in a closely fitting, conforming relationship so that the panels 38, 40 overlie and are in contact with the panels 24 and 26.

The cover 22 is preferably in the form of an aluminum foil/woven polypropylene laminate material 44 having a thickness of about 6.35 mm. The material 44 is illustrated in FIG. 5, and comprises a central sheet of woven polypropylene 46 with inner and outer aluminum foil sheets 48, 50 adhesively secured to the opposed faces of the sheet 46. This material has a heat reflectivity of about 97% and the primary function thereof is to reflect away from the inner cover 20 and carton 10. An alternate metallic layer may be in the form of a polyester film with aluminum particles electrostatically deposited on the film.

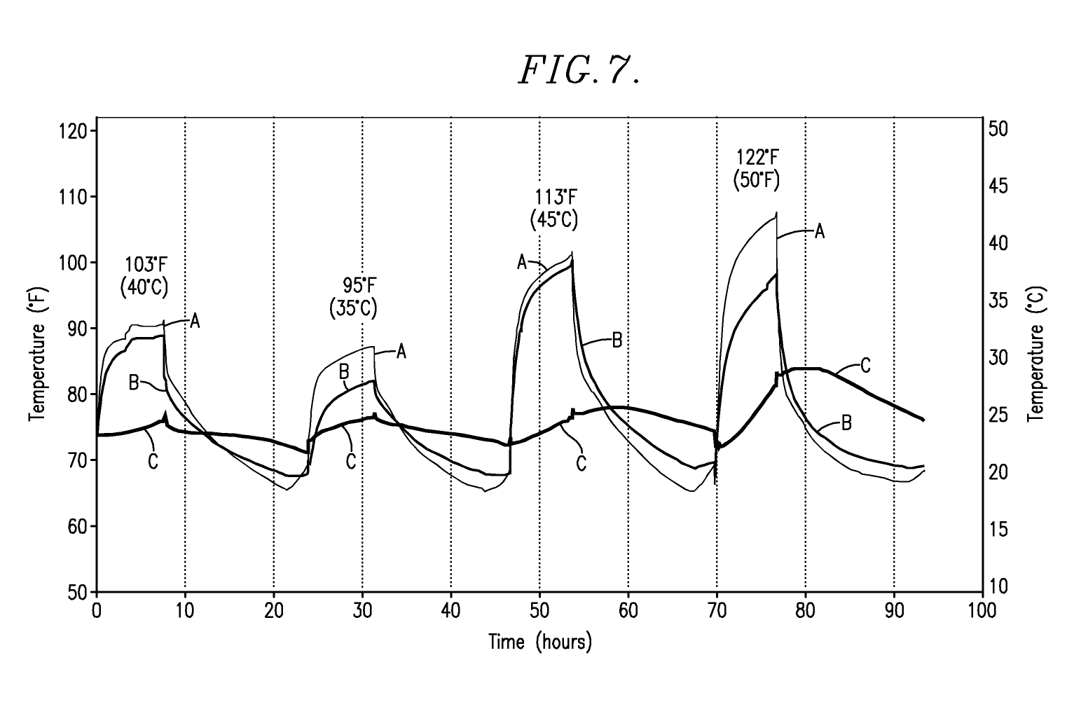

FIG. 7 illustrates a thermal test conducted to determine the efficiency of a cover assembly including inner PCM and outer heat reflective/insulating material. In the test, an uncovered first temperature control box, a second temperature control box covered only with the material 44, and a third temperature control box covered using both the PCM composite 29 and the material 44 were prepared and placed in a heat chamber. During Day 1, the heat chamber was set to 103° F. from 9:00 am 5:00 pm, and was thereafter allowed to cool from 5:00 pm to 9:00 am. Thereafter, the heat chamber was set to 95° F. and was heated/cooled according to the foregoing schedule. On Day 3, the heat chamber was set to 113° F. and was heated/cooled according to the foregoing schedule. Finally, on Day 4, the heat chamber was set to 122° F., and was heated/cooled according to the foregoing schedule. FIG. 7 illustrates the results of these tests. The Graph A gives the temperature readings in the uncovered first temperature control box, whereas the Graph B gives the temperature readings at the second temperature control box. The Graph C gives the temperature readings for the control box covered with both the composite 29 and material 44. As is readily seen, only the two-component combination (Graph C) provided acceptable temperature control in the test. Both the first and second test boxes gave unacceptable results, and would not adequately protect temperature-sensitive goods.

While the invention has been particularly described in the context of a quadrate carton with closely-conforming, telescoped inner and outer covers 20 and 22, the invention is not so limited. That is, the concept of the invention may be used to give temperature protection to a plurality of different cartons or the like, by first spreading a sheet of PCM composite over the cartons, followed by spreading a sheet of the heat-reflecting/insulating material over the PCM composite sheet. The two sheets may be in physical contact, or may be separated by an air space distance.

In other alternatives, the outer cover 20 maybe equipped with a metalized reflective layer only on the outer surface thereof. Also, while the covers 20, 22 have been shown as separate structural elements, it is within the invention to provide these covers as an interconnected, unitary assembly. For example, in the illustrated embodiment, the covers 20, 22 would be telescoped together and attached to form a unitary body. This would be advantageous in that installation of the assembly would be facilitated, i.e., the covers would not have to be separately mounted.

We claim:

1. A protection assembly designed to protect an object against undue temperature changes, comprising:
a first layer configured to be placed proximal to said object and including phase change material; and
a second layer configured to be placed over said first layer and remote from said object, said second layer comprising a heat-reflecting material.

2. The assembly of claim 1, said first layer including an inner sheet and an outer sheet, with said phase change material captively retained between said sheets.

3. The assembly of claim 2, said sheets formed of synthetic resin material joined at the margins thereof to form an internal pocket, said phase change material within said pocket.

4. The assembly of claim 1, said second layer including a metallic foil.

5. The assembly of claim 4, said second layer further including a sheet of heat-insulating synthetic resin material, with said metallic foil secured to the face of said second layer remote from said first layer.

6. The assembly of claim 5, said sheet of heat-insulating material comprising woven polypropylene, said outer layer of metallic foil being aluminum foil.

7. The assembly of claim 5, said sheet of heat-insulating synthetic resin material having said metallic foil secured to the opposed faces thereof.

8. The assembly of claim 1, said object being a quadrate carton, said first layer having a top panel and four depending sidewall panels, said top and sidewall panels configured to be placed over said carton in closely-conforming relationship with the carton.

9. The assembly of claim 8, said second layer having a top panel and four depending sidewall panels, the top and sidewall panels of the second layer configured to be placed over said first layer in closely-conforming relationship therewith.

10. The assembly of claim 1, said phase change material being a solid-liquid phase change material.

11. The assembly of claim 1, said first and second layers being separable from each other.

12. A method of protecting an object against undue temperature changes, comprising the step of placing the assembly of claim 1 over said object.

13. The method of claim 12, including the steps of initially placing said first layer over said object, and then placing said second layer over said first layer.

14. A method of protecting an object against undue temperature changes, comprising the step of placing the assembly of claim 5 over said object.
